(19) United States
(12) Patent Application Publication
(10) Pub. No.: US 2013/0080474 A1
(43) Pub. Date: Mar. 28, 2013

(54) ACCELERATING RECURSIVE QUERIES

(71) Applicants: Bin Zhang, Fremont, CA (US); Meichun Hsu, Los Altos Hills, CA (US)

(72) Inventors: Bin Zhang, Fremont, CA (US); Meichun Hsu, Los Altos Hills, CA (US)

(21) Appl. No.: 13/246,771

(22) Filed: Sep. 27, 2011

(51) Int. Cl. G06F 7/00

(52) U.S. Cl. 707/797; 707/E17.044

(57) ABSTRACT

A computer apparatus and related method to accelerate recursive queries is provided. In one aspect, a node located within a data structure may be accessed. The data structure may emulate a hierarchy of interlinked nodes. In another aspect, a series of bits may be generated that indicate a level of the node within the hierarchy and that outline a unique path of interlinked nodes toward the node.

### BACKGROUND

Databases utilize various hierarchical data structures of interlinked nodes to manage stored data. The interlinked nodes may form a tree-like hierarchy of parent child relationships. Tree-like data structures may include a root node and one or more interior nodes leading to a plurality of leaf nodes. Interior nodes usually contain two or more values associated with data stored in lower ordered child nodes. Structured query language (“SQL”) is a popular programming language used to submit database commands, such as a query, a data update, or a data insert. SQL programmers frequently encounter situations requiring nested queries (i.e., query within a query) otherwise known as recursive queries.

### BRIEF DESCRIPTION OF THE DRAWINGS

FIG. 1 is an illustrative system in accordance with aspects of the application.

FIG. 2 is a close up illustration of a computer apparatus in accordance with aspects of the application.

FIG. 3 is an illustrative database table.

FIG. 4 is a flow diagram in accordance with aspects of the application.

FIG. 5 is a working example of a data structure in accordance with aspects of the application.

FIG. 6 is a working example of a database table in accordance with aspects of the application.

FIG. 7 is a further working example in accordance with aspects of the application.

### DETAILED DESCRIPTION

Various examples disclosed herein provide an apparatus and method to accelerate recursive queries. Many recursive queries obtain the desired information by performing repeated searches on database tables. These repeated searches often lead to performance degradation. In one aspect of the present application, a node located within a data structure may be accessed. The data structure may emulate a hierarchy of interlinked nodes. In another aspect, a series of bits may be generated. The series of bits may indicate a level of the node within the hierarchy and may outline a unique path of interlinked nodes toward the node.

The aspects, features and advantages of the application will be appreciated when considered with reference to the following description of examples and accompanying figures. The following description does not limit the application; rather, the scope of the application is defined by the appended claims and equivalents.

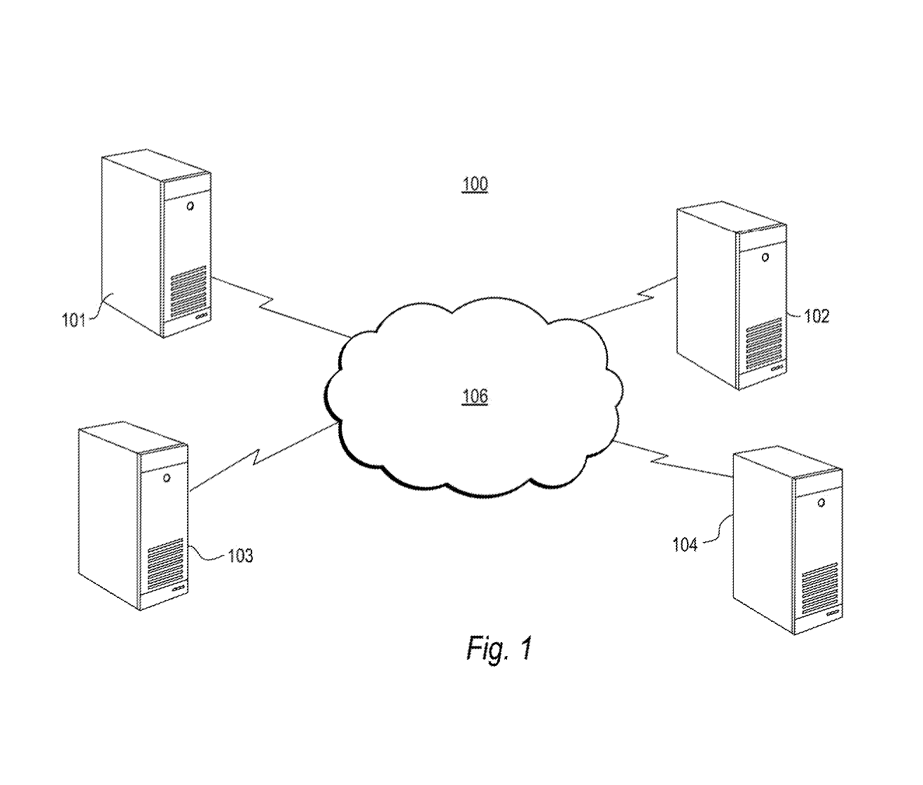

FIG. 1 presents a schematic diagram of an illustrative system 100 depicting various computers 101, 102, 103, and 104 used in a networked configuration. Each computer may comprise any device capable of processing instructions and transmitting data to and from other computers, including a laptop, a full-sized personal computer, a high-end server, or a network computer lacking local storage capability. Moreover, each computer may comprise a mobile device capable of wirelessly exchanging data with a server, such as a mobile phone, a wireless-enabled PDA, or a tablet PC. Each computer apparatus 101, 102, 103, and 104 may include all the components normally used in connection with a computer. For example, each computing device may have a keyboard, a mouse and/or various other types of input devices such as pen-inputs, joysticks, buttons, touch screens, etc., as well as a display, which could include, for instance, a CRT, LCD, plasma screen monitor, TV, projector, etc.

The computers or devices disclosed in FIG. 1 may be interconnected via a network 106, which may be a local area network (“LAN”), wide area network (“WAN”), the Internet, etc. Network 106 and intervening computer devices may also use various protocols including virtual private networks, local Ethernet networks, private networks using communication protocols proprietary to one or more companies, cellular and wireless networks, instant messaging, HTTP and SMTP, and various combinations of the foregoing. Although only a few computers are depicted in FIG. 1, it should be appreciated that a typical network can include a large number of interconnected computers.

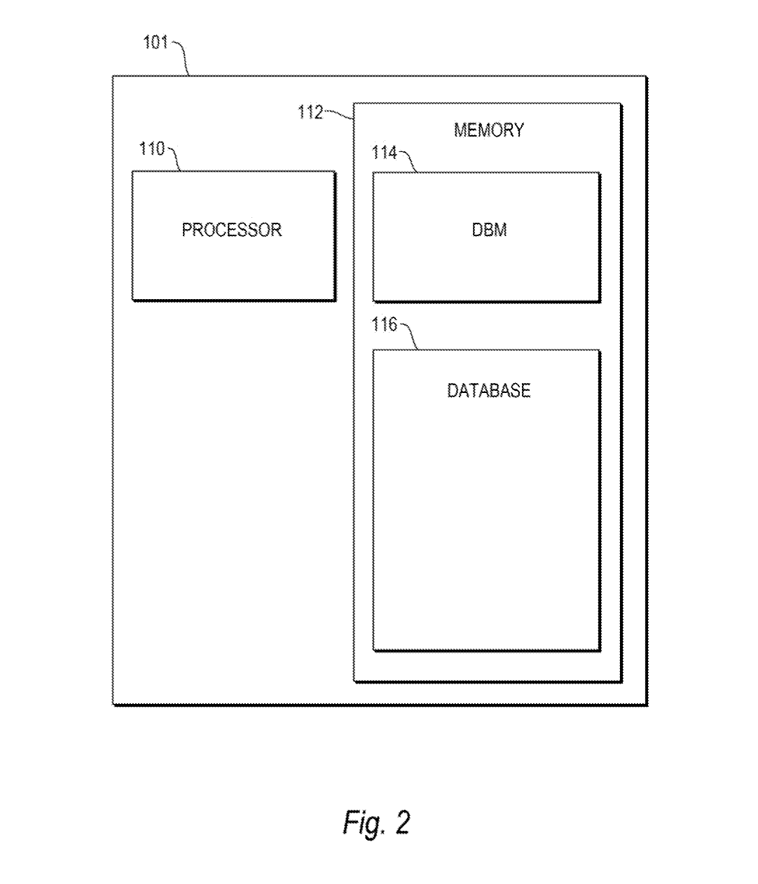

FIG. 2 is a close up illustration of computer apparatus 101. In the example of FIG. 2, computer apparatus 101 is a database server with a processor 110 and memory 112. Memory 112 may store database management (“DBM”) instructions 114 that may be retrieved and executed by processor 110. Furthermore, memory 112 may contain a database 116 containing data that may be retrieved, manipulated, or stored by processor 110. In one example, memory 112 may be a random access memory (“RAM”) device. Alternatively, memory 112 may comprise other types of devices, such as memory provided on floppy disk drives, tapes, and hard disk drives, or other storage devices that may be directly or indirectly coupled to computer apparatus 101. The memory may also include any combination of one or more of the foregoing and/or other devices as well. The processor 110 may be any number of well known processors, such as processors from Intel Corporation. In another example, processor 110 may be a dedicated controller for executing operations, such as an application specific integrated circuit (“ASIC”).

Although FIG. 2 functionally illustrates the processor 110 and memory 112 as being within the same block, it will be understood that the processor and memory may actually comprise multiple processors and memories that may or may not be stored within the same physical housing. For example, any one of the memories may be a hard drive or other storage media located in a server farm of a data center. Accordingly, references to a processor, computer, or memory will be understood to include references to a collection of processors, computers, or memories that may or may not operate in parallel.

As noted above, computer apparatus 101 may be configured as a database server. In this regard, computer apparatus 101 may be capable of communicating data with a client computer such that computer apparatus 101 uses network 106 to transmit information for presentation to a user of a remote computer. Accordingly, computer apparatus 101 may be used to obtain database information for display via, for example, a web browser executing on computer 102. Computer apparatus 101 may also comprise a plurality of computers, such as a load balancing network, that exchange information with different computers of a network for the purpose of receiving, processing, and transmitting data to multiple client computers. In this instance, the client computers will typically still be at different nodes of the network than any of the computers comprising computer apparatus 101.

The DBM instructions 114 residing in memory 112 may comprise any set of instructions to be executed directly (such as machine code) or indirectly (such as scripts) by the processor(s). In that regard, the terms “instructions,” “steps” and “programs” may be used interchangeably herein. The instructions may be stored in any computer language or format, such as in object code or modules of source code. Furthermore, it is understood that the instructions may be implemented in the form of hardware, software, or a combination of hardware and software and that the examples herein are merely illustrative. DBM instructions 114 may configure processor 110 to reply to database queries, to update the database, to provide database usage statistics, or to serve any other database related function. Requests for database access may be transmitted from a remote computer via network 106. For example, computer 104 may be at a sales location communicating new data through network 106. This data may be, for example, new employee, sales, or inventory data. At the same time, computer 103 may be at a corporate office submitting database queries to DBM instructions 114, which may configure processor 110 to search database 116 and return the relevant data to computer 103. Database 116 may be arranged as a balanced hierarchical tree like data structure, such as a binary tree, a B plus tree, or a B link tree.

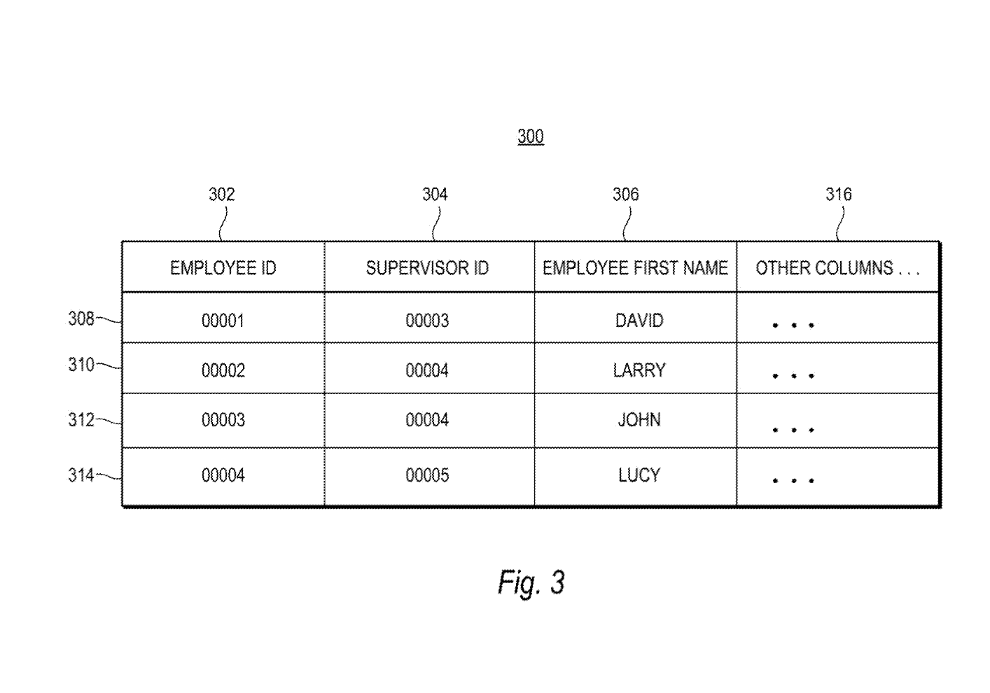

FIG. 3 depicts an illustrative employee table 300 that may be maintained in database 116. Employee table 300 may contain four records 308, 310, 312, and 314. Employee table 300 may also contain at least three columns: an employee identifier 302, a supervisor identifier 304, and an employee's first name 306. Additional columns 316 may contain other miscellaneous information, such as address, social security number, or title. The employee identifier may be a unique reference associated with each employee. The supervisor identifier may be the employee identifier associated with each employee's supervisor. For example, the supervisor identifier associated with “Larry” is “00004,” which is the employee identifier associated with “Lucy.” Thus, “Lucy” is the supervisor of “Larry.” The following is an illustrative SQL query that may be used to obtain the employee identifier of an employee named “David” from employee table 300:

```
    select Employee_Id
  from EmployeeTable
where EmployeeFirstName=‘David’
```

The straightforward query above will search for the record whose “EmployeeFirstName” column equals “David” and will return the employee identifier associated therewith, which is “00001” in the example of FIG. 3. While some data requirements may be met with simple SQL statements like the one above, others require SQL queries that are complex and cumbersome. For example, an SQL programmer may be required to develop a query that returns the name of the supervisor of David's supervisor. The SQL for obtaining this information from employee table 300 may be the following:

```
select EmployeeFirstName
from EmployeeTable
where Employee_Id IN
( select Supervisor_Id
  from EmployeeTable
  where Employee_Id IN
  ( select Supervisor_Id
  from EmployeeTable
  where EmployeeFirstName=‘David’))
```

The SQL above has a main query having two nested queries enclosed within two pairs of parenthesis. The inner most nested query returns the supervisor identifier associated with the employee named “David.” The supervisor identifier associated with “David” is “00003,” as shown in record 308 of employee table 300. In turn, the second nested query joins the supervisor identifier “00003” with the employee identifier column to obtain the record of David's supervisor. The name of the employee associated with employee identifier “00003” is the employee named “John,” as shown in record 312 of employee table 300. Thus, John is David's supervisor. Finally. the main query receives the supervisor identifier associated with “John,” which is “00004,” and also joins the supervisor identifier with the employee identifier column to obtain the record of John's supervisor. The employee associated with employee identifier “00004” is “Lucy,” which is record 314 of employee table 300. Thus, the supervisor of David's supervisor is the employee named “Lucy.” In order to successfully execute the above query, DBM instructions 114 must access the employee table multiple times. During spikes in database activity, such queries can hinder the overall performance of the database, especially if the table houses an extremely large number of data records. Furthermore, some queries may be required to have more than two nested queries.

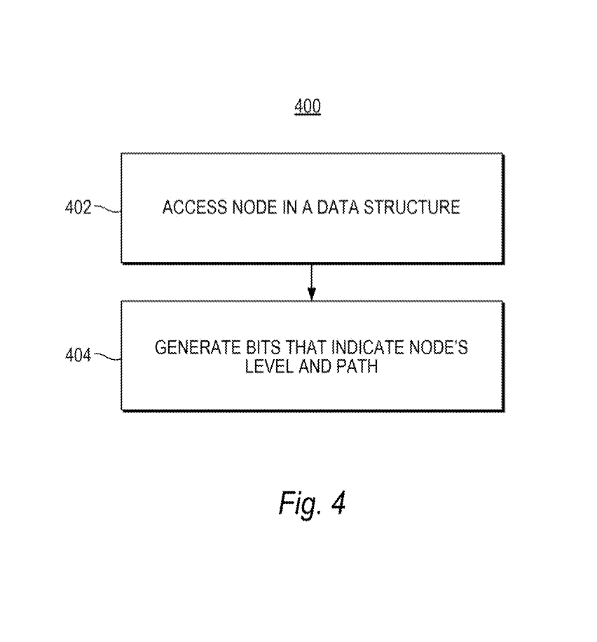

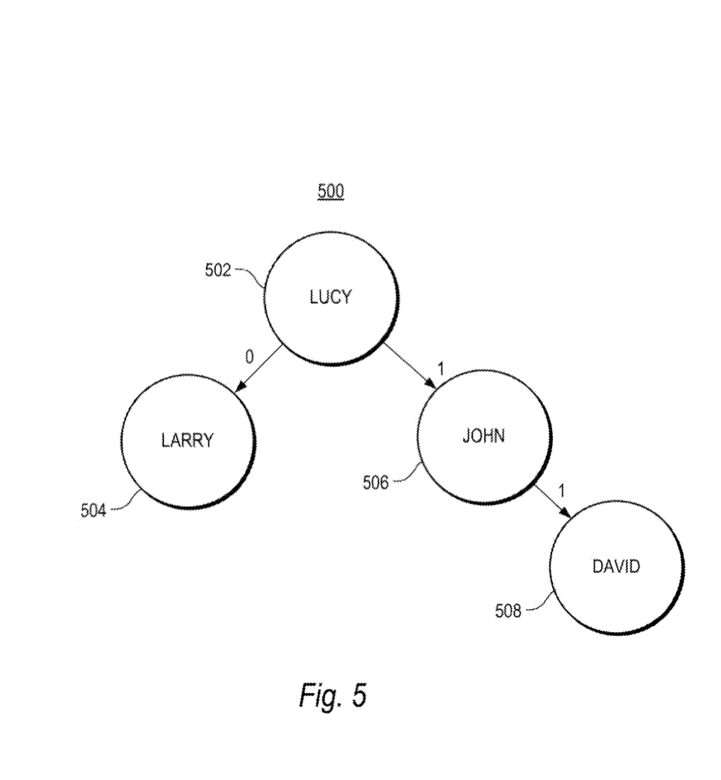

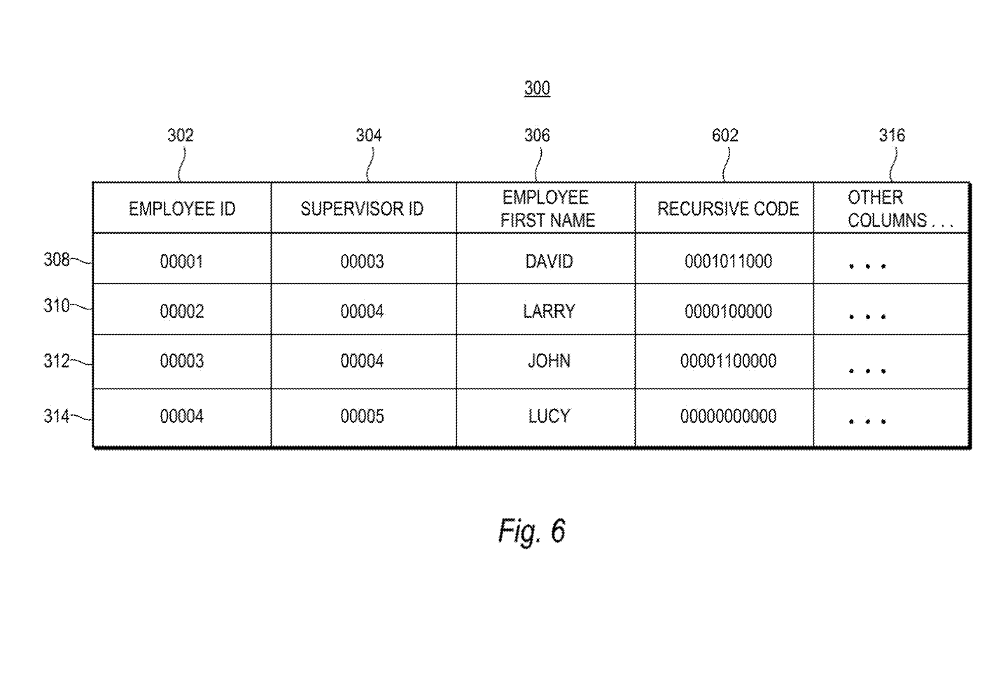

One working example of an apparatus and method to accelerate recursive queries and to minimize their impact on database performance is illustrated in FIGS. 4-6. In particular, FIG. 4 illustrates a flow diagram of a process for accelerating recursive queries. FIGS. 5-6 show various aspects of data structures and databases. The actions shown in FIGS. 5-6 will be discussed below with regard to the flow diagram of FIG. 4.

As shown in block 402 of FIG. 4, a node located within a hierarchical data structure of interlinked nodes may be accessed. The node may be accessed by DBM instructions 114. FIG. 5 shows an illustrative binary tree data structure 500 that corresponds to records 308, 310, 312, and 314 of employee table 300. Each node of binary tree 500 may represent a record of employee table 300. For ease of illustration, only the employee first name column is shown in each node. Binary tree 500 may have a root node 502 containing the record for the employee “Lucy.” Root node 502 may be associated with two child nodes 504 and 506, which may extend to the left and to the right of root node 502 respectively. Node 504 may be the record for “Larry” and node 506 may be the record for “John.” Node 506 is shown having a right child node 508, which is the record for “David.” As further illustrated in FIG. 5, each left node of the tree may be associated with a link value of “0” and each right node of the tree may be associated with a link value “1.”

Referring back to FIG. 4, a series of bits may be generated that indicate a level of the node within the hierarchy and that outline a unique path of interlinked nodes toward the accessed node, as shown in block 404. The series of bits may be associated with each node and may be referred to as the node's recursive code. In one example, the recursive code is a sixty four bit integer. If a sixty four bit integer is used, the first six bits may be used to represent the level of a node and the other fifty eight bits may be used to represent the path toward the node. As noted above, each right and left link to a child node may be associated with a link value of “1” and “0” respectively. The path toward the node may be coded as a series of 1's and 0's (i.e., right and left). However, it is understood that other coding strategies may be utilized, including associating a right node with a “0” and associating a left node with a “1.”

Referring back to the illustrative binary tree of FIG. 5, root node 502 of FIG. 5 may be at the root level, thus the level for “Lucy” may be, for example, level zero, which equals “00000” in binary. Since “Lucy” is at the root of the tree, there are no links leading toward “Lucy.” Thus, the path for “Lucy” may also be zero, which may be coded as “00000.” Both the path and the level may be combined, resulting in a recursive code of “0000000000.” Node 504, which represents the record for “Larry,” may be one level below the root of the tree. The level may be represented in binary as “00001.” Since “Larry” is the left child of “Lucy,” the link leading toward “Larry” may be associated with a link value of “0.” Thus, the path toward “Larry” may also be coded as “00000.” As with root node 502, the recursive code associated with node 504 (i.e., Larry) may also be a combination of the level and the path, resulting in a recursive code of “0000100000,” which may be read from left to right in this example. Node 506, which represents the record for “John,” is also one level below the root. However, the link to John is associated with a link value of “1,” which may be coded as “1000.” The path toward a node may also be read from left to right and any trailing zeros may be ignored. Thus, the resulting recursive code for John may be “0000110000.” Finally, node 508, which represents the record for “David,” is located at level two, which equals “00010” in binary, and has a path comprising two link values 11, which may be coded as “11000.” Thus, the resulting recursive code for “David” may be “0001011000.”

In one example, a request for a specific node's level or path may be received. This request may come from a remote computer 102, 103, or 104 through a series of commands attempting to calculate a node's recursive code. For example, the complex nested query shown above, which attempted to find the supervisor of David's supervisor, can be rewritten such that the employee table is only accessed once. This may be accomplished by performing bit operations on the appropriate recursive code. FIG. 6 illustrates one approach that may be utilized to associate each node with its respective code. FIG. 6 reproduces employee table 300, but with an additional column 602 containing the recursive code associated with each record. Each code may be generated upon creation of its corresponding record. The recursive code may be used to locate data that would normally require nested queries to find. If a request for a node's level or path is received, the requested level or path thereof may be extracted and transmitted back to the requesting entity in response to the request. An illustrative function named level( ) may be utilized to extract and return the level of a given node within a tree. Another illustrative function named path( ) may be utilized to extract and return the path of the given node within the tree. As illustrated in FIG. 6, the recursive code for “David” is “0001011000.” This code may be used to begin the search for the supervisor of David's supervisor with a series of bit operations. The bit operations may be used to adjust the level indicated in the recursive code until the level matches that of the node storing the requested data. The bit operations may also be used to adjust the unique path indicated in the recursive code until the unique path matches that of the node storing the requested data.

The following illustrative pseudo code may be utilized to find David's supervisor by adjusting the bits of David's recursive code.

```
David=0001011000
david_supervisor_level=level(David) − 1 = 2−1=00001
  david_supervisor_path=truncate−1bit(path(David)=10000
  david_supervisor_level & david_supervisor_path=0000110000
```

The first line of the above pseudo code is an instruction to initialize an arbitrary user defined variable to the recursive code of “David.” The second line of pseudo code above is an instruction to extract the level from David's recursive code, which is level two (i.e., 00010) in the present example, and to subtract one therefrom, which results in the level of David's supervisor. In the present example, the level of David's supervisor is one, which equals “00001” in binary. The third line is an instruction to determine the path of David's supervisor. David's path, which is “11000” in the present example, may be extracted from the recursive code and his supervisor's path may be derived by truncating the leftmost bit or link value, which results in a path code of “10000.” The fourth line of pseudo code above is an instruction to combine or concatenate the level and the path in order to arrive at the recursive code of David's supervisor, “0000110000.” As shown in FIG. 6, the recursive code “0000110000” is associated with record 312, which is the record for “John.” Thus, “John” is David's supervisor. Now that the recursive code for “John” has been derived, the same three illustrative pseudo commands may be utilized to derive the recursive code of John's supervisor:

supervisor2_level=david_supervisor_level − 1 = 00000
supervisor2_path=truncate1bit(david_supervisor_path)=00000
supervisor2=supervisor2_level&supervisor2_path = 0000000000

The first line of the above pseudo code is also an instruction to subtract one from John's level to arrive at the level of his supervisor, which is “00000” in the present example. The second line is an instruction to truncate the leftmost bit or link value from John's path to arrive at his supervisor's path, which is also “00000” in the present example. The last line of pseudo code above is an instruction to combine or concatenate the path and the level to arrive at the recursive code of the supervisor of David's supervisor, and to store the recursive code in an arbitrary user defined variable named supervisor 2. The recursive code of the supervisor of David's supervisor is “0000000000” in the present example. Now that the recursive code has been determined without accessing employee table 300, the table may now be accessed without nested queries:

select Employeefirstname
from Employeetable
where recursive_code = supervisor2

The above select statement obtains the desired record without multiple scans of employee table 300. As shown in FIG. 6, the employee associated with the recursive code of “0000000000” is “Lucy.” Thus, “Lucy” is the supervisor of David's supervisor. Redundant access of the employee table may be avoided by manipulating the bits of an appropriate recursive code.

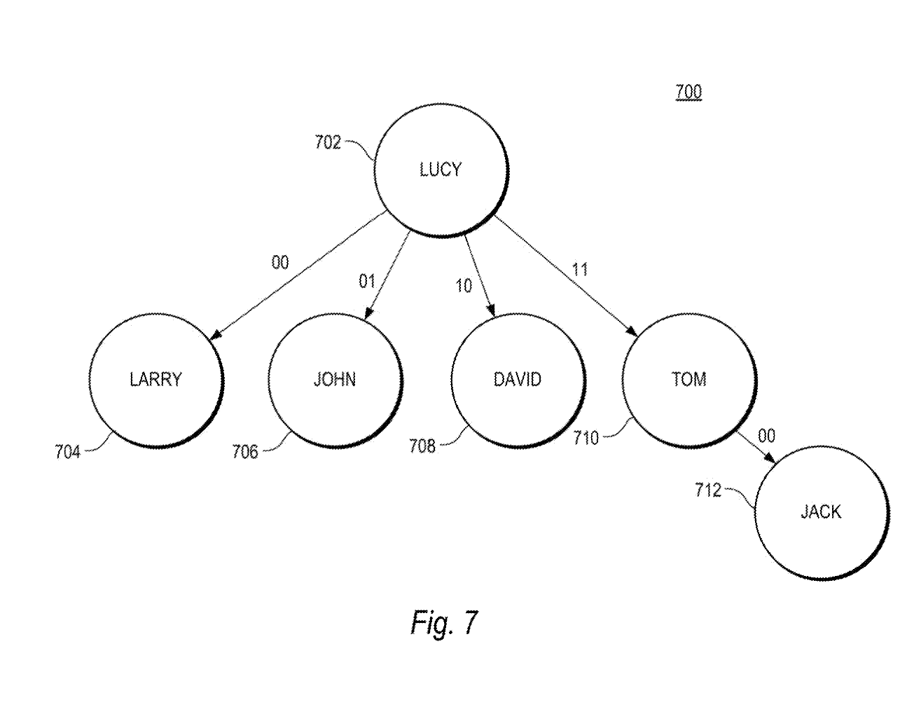

While the foregoing examples show the use of binary trees, the apparatus and method disclosed above may be utilized with any hierarchical tree data structure. FIG. 7 shows a different illustrative tree data structure having a root node 702 with four child nodes 704, 706, 708, and 710. Node 710 is shown having one child node 712. As with the tree illustrated in FIG. 5, each node may represent a different employee. By way of example, the binary tree in FIG. 5 allowed a maximum of two child nodes per node, a right node associated with a link value of “1” and a left node associated with a link value of “0.” Since the tree illustrated in FIG. 7 is shown having more than just a right node and a left node, a single bit of “1” or “0” may lead to ambiguous codes and may not be feasible. Thus, the link values may have a predetermined bit size that is greater than one bit. For example, the path from Lucy to Tom may be associated with a link value of “11” and the path from Lucy to Jack may be associated with a link value of “1100.” In one example, the bit size of each link value is the logarithm base two of the maximum number of child nodes permitted for a node in the data structure. Particularly, if a maximum of 2ⁿ child nodes are allowed, each link toward a given node may be associated with a link value that is n bits in length (i.e., log₂(2ⁿ)=n).

The recursive codes and illustrative functions described above may be used in a variety of queries in lieu of or in conjunction with conventional database query languages, such as SQL. The following examples demonstrate different types of queries that may utilize recursive codes. In the first example, recursive codes may be used to identify nodes along a particular branch of a binary tree. Given the recursive codes for nodes A and B, where B is a descendant of A, the nodes on the downward path between A and B may be identified with the following illustrative pseudo code:

A=0000110000
B=0010011110
Node1=(level(A)+1&truncate(path(B),level(A)+1)= 0001011000
Node2=(level(B)−1&truncate(path(B),level(B)−1)= 0001110000

The first two lines of pseudo code above are instructions to initialize variable A and B to their respective recursive codes. Node A may be at level 1 and may have a path comprising a link value of 1, thus node A may be one level below the root node and may extend to the right thereof. Node B may be at level 4 and may have a path comprising link values 1111, thus node B may be four levels below the root node. In this example, there are two nodes between nodes A and B. The third line of pseudo code is an instruction to derive the recursive code of the node one level higher than Node A and two levels lower than Node B, which is Node 1 in this example. The level of Node 1 may be derived by incrementing the level of node A by one, and the path may be derived by truncating the first two bits or link values from the path of node B. The fourth line of pseudo code above is an instruction to derive the recursive code of the second node between Node A and Node B, which is Node 2 in this example. Node 2 may be one level below Node B. The recursive code for Node 2 may be derived by subtracting one from the level of B and truncating the first link value from the path of B.

The following pseudo code may derive the recursive code for the common ancestor of Node A and Node B above. Given the above values of the recursive codes of Node A and Node B, the common ancestor is the root node, which may have a recursive code of zero.

```
K=min(level(A), level(B));
for (i=1;i<=K;i++) {
    if (the ith bit of path(A) not equal to the ith bit of  path(B)){
      common_ancestor_level = i−2
      common_ancestor_path = truncate(path(A),i−1)
common_ancestor=common_ancestor_level&commonancestor_path
    }
```

The first line of the pseudo code above is an instruction to initialize K to the level of node A or node B, whichever is lower. Assuming that each link value is one bit in length, the illustrative for-loop compares each link value of path(A) and path(B). The loop terminates when the variable i is greater than or equal to K or when the ith bit of path(A) and path(B) are not equal. If the ith bit of the paths are not equal the level of the common ancestor is derived by subtracting 2 from i, as shown in the fourth line of pseudo code above. The fifth line of pseudo code above truncates the first (i−1) link values or bits from the path of A to arrive at the path of the common ancestor. The sixth line of pseudo code concatenates the level and the path to arrive at the recursive code of the common ancestor.

Popular tree traversal orderings, such as depth-first traversal and breadth first traversal may utilize recursive codes. For example, the following query may be used for pre-order depth-first traversal:

select * from Table order by path(recursive_code)ascending,level(recursive_code)ascending

The above query extracts the path and level of every node associated with the records in “Table” and organizes the results in ascending order by path then by level. Thus, the results are organized in pre-order depth-first order. To convert the above query to in-order or post-order depth first traversal, a memory stack may be utilized to save the nodes (i.e., sub-tree roots) along the path. The following query may be used for breadth first traversal:

select * from Table order by level(recursive_code)ascending,path(recursive_code)ascending,

The “order by” clause of the above query is reversed so that the results are returned in ascending ordered first by level then by path. The results of the illustrative query above will be organized in breadth first order.

Advantageously, the above-described apparatus and method enhances database performance by accelerating recursive queries. Rather than searching through database tables multiple times, a recursive query may be carried out with a series of bitwise functions. In this regard, database tables are more available to multiple processes. In turn, users experience less performance degradation.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, processes may be performed in a different order or concurrently, and steps may be added or omitted.

1. A computer apparatus comprising:
a processor to:
access a first node located within a hierarchy of interlinked nodes, the hierarchy of interlinked nodes representing a database;
generate a recursive code, the recursive code comprising a series of bits indicating a level of the first node within the hierarchy and outlining a unique path of interlinked nodes toward the first node;
access a request for a second node within the hierarchy of interlinked nodes; and
perform at least one bitwise operation on the recursive code of the first node to obtain the second node within the hierarchy of interlinked nodes.

2. The computer apparatus of claim 1, wherein the first node and the second node each contains a record of data.

3. The computer apparatus of claim 2, wherein the processor further configured to associate each node in the hierarchy of interlinked nodes with a recursive code.

4. The computer apparatus of claim 1, wherein the at least one bitwise operation comprises:
extraction, from the recursive code, the level of the first node.

5. The computer apparatus of claim 1, wherein the at least one bitwise operation comprises:
extraction, from the recursive code, the unique path to the first node.

6. The computer apparatus of claim 5, wherein each link in the unique path toward the node is associated with a link value, the link value having a predetermined bit size.

7. The computer apparatus of claim 6, wherein the predetermined bit size is a logarithm base two of a maximum number of child nodes permitted for a given node in the hierarchy of interlinked nodes.

8. A computer apparatus comprising:
a processor to:
receive a request for data stored in a node of a hierarchical data structure of interlinked nodes, the request comprising a recursive code, the recursive code comprising a series of bits indicating a level of a given node within the hierarchical data structure and outlining a unique path of interlinked nodes toward the given node, the given node being different than the node storing the requested data;
perform bit operations on the recursive code to find the node storing the requested data; and
return the requested data in response to the request.

9. The computer apparatus of claim 8, wherein the bit operations adjust the level indicated in the recursive code until the level matches that of the node storing the requested data.

10. The computer apparatus of claim 8, wherein the bit operations adjust the unique path indicated in the recursive code until the unique path matches that of the node storing the requested data.

11. The computer apparatus of claim 10, wherein each link in the unique path toward the given node is associated with a link value, the link value having a predetermined bit size.

12. The computer apparatus of claim 11, wherein the adjustment comprises truncating at least one link value from the unique path.

13. The computer apparatus of claim 11, wherein the predetermined bit size is a logarithm base two of a maximum number of child nodes permitted for any node in the hierarchy of interlinked nodes.

14. A method to accelerate recursive queries, the method comprising:
accessing, with a processor, a first node located within a data structure, the data structure emulating a hierarchy of interlinked nodes;
generating, with the processor, a recursive code, the recursive code comprising a series of bits that indicate a level of the first node within the hierarchy and that outlines a unique path of interlinked nodes toward the first node;
accessing, using the processor, a request for a second node within the hierarchy of interlinked nodes; and
performing, using the processor, at least one bitwise operation on the recursive code of the first node to obtain the second node in response to the request.

15. The method of claim 14, wherein each node in the hierarchy of interlinked nodes contains a record of data.

16. The method of claim 15, further comprising associating, with the processor, the record in each node with a recursive code.

17. The method of claim 14, wherein performing the at least one bitwise operation comprises
extracting from the recursive code, with the processor, the level of the first node.

18. The method of claim 14, wherein performing the at least one bitwise operation comprises
extracting from the recursive code, with the processor, the unique path of interlinked nodes to the first node.

19. The method of claim 18, wherein each link in the unique path toward the first node is associated with a link value, the link value having a predetermined bit size.

20. The method of claim 19, wherein the predetermined bit size is a logarithm base two of a maximum number of child nodes permitted for a given node in the hierarchy of interlinked nodes.
